(19) United States
(12) Patent Application Publication
(10) Pub. No.: US 2012/0077476 A1
(43) Pub. Date: Mar. 29, 2012

(54) SYSTEM AND METHOD FOR UTILIZING MOBILE TELEPHONES TO COMBAT CRIME

(75) Inventors: Theodore G. Paraskevakos, Timonium, MD (US); Christopher G. George, Timonium, MD (US); Steven J. Cramer, Timonium, MD (US); Sabarikanth Perumal, Timonium, MD (US); Petros Liakopoulos, Athens (GR); Hamlet Ambarsoom, Herndon, VA (US)

(73) Assignee: Theodore G. Paraskevakos, Timonium, MD (US)

(21) Appl. No.: 13/237,433

(22) Filed: Sep. 20, 2011

Related U.S. Application Data
(60) Provisional application No. 61/385,857, filed on Sep. 23, 2010.

(51) Int. Cl. H04W 4/00

(52) U.S. Cl. 455/414.2

(57) ABSTRACT

The system and method described herein may validate and trace currency serial numbers, which may be extracted from the currency with a mobile telephone camera. The mobile telephone may use a messaging service to transmit the extracted serial numbers to a data processing facility, which may then compare the serial numbers transmitted from the mobile telephone to a list that includes information identifying currencies that are invalid, counterfeit, or known to be associated with criminal activities. In response to the extracted serial numbers matching any of the identifying information in the list, the currency may be deemed invalid. Furthermore, biometric information or information read from identification documents associated with an individual using the invalid or wanted currency may be obtained to help later identify the individual, and triangulation techniques may be used to track the mobile telephone and apprehend the individual.

### CROSS-REFERENCE TO RELATED APPLICATIONS

This application claims the benefit of U.S. Patent Application Ser. No. 61/385,857, entitled “System and Method for Utilizing Mobile Telephones to Combat Crime,” filed Sep. 23, 2010.

In addition, this application is related to U.S. patent application Ser. No. 10/740,587, entitled “Intelligent Currency Validation Network,” filed Dec. 22, 2003, which issued as U.S. Pat. No. 7,006,664 on Feb. 28, 2006, U.S. patent application Ser. No. 11/407,962, entitled “System and Method for Intelligent Currency Validation,” filed Apr. 21, 2006, which issued as U.S. Pat. No. 7,454,049 on Nov. 18, 2008, U.S. patent application Ser. No. 11/819,887, entitled “Device and Method for Preventing Counterfeiting Using a Currency Serial Number Reader,” filed Jun. 29, 2007, which issued as U.S. Pat. No. 7,567,698 on Jul. 28, 2009, and U.S. patent application Ser. No. 12/272,306, entitled “System and Method for Intelligent Currency Validation,” filed Nov. 17, 2008, which issued as U.S. Pat. No. 7,724,938 on May 25, 2010.

The contents of the above-referenced U.S. Provisional patent application, U.S. patent applications, and issued U.S. patents are hereby incorporated by reference in their entirety.

### FIELD OF THE INVENTION

The invention generally relates to a system and method for utilizing mobile telephones to combat crime, and in particular, to reading and authenticating currency serial numbers using mobile or cellular telephones to prevent counterfeiting, drug trafficking, money laundering, terrorism, corruption, theft, kidnapping, robbery, and other criminal activities that typically include cash exchanges.

### BACKGROUND OF THE INVENTION

Since the inception of the use of paper money, central banks and governments have engaged in substantial efforts to protect currencies from counterfeiting and use in criminal activities that typically involve cash exchanges (e.g., drug trafficking, money laundering, terrorism, corruption, theft, kidnapping, robbery, etc.). Even so, perpetrators often exploit new technologies to duplicate the security features of legitimate currencies, which typically results in central banks and governments struggling to stay ahead of counterfeiters and other criminals exchange legitimate and illegitimate currencies to further criminal activities. One technique that has been used in an effort to prevent counterfeiting, armed robbery, money laundering, extortion, terrorism, embezzlement, and other money-related crime includes undermining the anonymity of cash. For example, as described in U.S. Pat. No. 3,727,003, entitled “Decoding and Display Apparatus for Groups of Pulse Trains,” which issued on Apr. 10, 1973, and U.S. Pat. No. 3,812,296, entitled “Apparatus for Generating and Transmitting Digital Information,” which issued on May 21, 1974, the contents of which are hereby incorporated by reference in their entirety, undermining the anonymity of telephony with Caller* ID® systems that remove anonymity from a caller's telephone number has been highly successful in preventing phishing, fraud, and other telephone-related crime world-wide.

Similarly, because counterfeiters often duplicate existing serial numbers or use serial numbers that fall out of range from the banknote's denomination, effectively reading and authenticating the serial number on the banknote can remove anonymity from currency. In particular, a perpetrator's attempts to counterfeit currency could be scientifically and positively determined from the serial number, which would force the perpetrator to invent new serial numbers to avoid detection, a logically impracticable and very difficult task. Nonetheless, existing systems that attempt to remove anonymity from currency typically cannot adequately read and authenticate currency serial numbers, whereby the existing systems tend to fall short in optimally preventing or detecting current counterfeit schemes. For example, counterfeiters sometimes create “Supernotes,” which are near perfect counterfeit bills printed and circulated outside of the United States, with central banks and governments in unfriendly countries often assisting in creating the “Supernotes.” Furthermore, from time to time, counterfeiters have deliberately circulated “Supernotes” with small imperfections that can be detected to divert the attention of authorities. Consequently, because existing systems cannot adequately detect or otherwise distinguish the imperfect “Supernotes,” absolutely perfect “Supernotes” can then circulate undetected.

Accordingly, due to these and other problems, existing systems that attempt to prevent currencies from being counterfeited and used in criminal activities that involve cash exchanges suffer from various drawbacks.

### SUMMARY OF THE INVENTION

According to one aspect of the invention, the system and method described herein may generally utilize mobile telephones to combat crime. In particular, the system and method described herein may provide a capability to scan any currency in any location worldwide, whereby increasing a number of banknotes that are scanned and prepared may increase a likelihood that “wanted” banknotes will be found. Furthermore, the system and method described herein may convert and suppress data needed to transfer currency serial numbers to a central data processing facility, which may provide capabilities to validate currency serial numbers quickly and economically. Moreover, because the system and method described herein can scan currency in any worldwide location, any currency that passes through a bank or other financial institution can become “bait” money that may be validated and traced to detect use in criminal activities. For example, any currency documents located in a bank or other financial institution during a robbery may be linked to a limited number of mobile or cellular telephones present in the bank or other financial institution during the robbery, wherein the currency documents and mobile or cellular telephones present in the bank or other financial institution during the robbery may be tracked to locate and apprehend the perpetrators. Additionally, the system and method described herein may be used to scan or read various other documents that may be susceptible to fraud or otherwise involved in criminal activity, wherein the other documents may include negotiable instruments, drivers' licenses, license plates, passports, visas, and student identification cards, among others, without limitation.

According to one aspect of the invention, the system and method described herein may generally include extracting serial numbers or reading other information that identifies currency, negotiable instruments, drivers licenses, license plates, passports, visas, student identification cards, or other suitable documents with any currently available or future-developed mobile or cellular telephone (e.g., 3G mobile or cellular telephones, 4G mobile or cellular telephones, etc.). In one implementation, the serial numbers or other information that identifies the documents may be extracted or otherwise read with a camera located on the mobile or cellular telephone, whereby alphanumeric characters that represent the serial numbers or other information that identifies the documents may be transmitted from the mobile or cellular telephone using a messaging service. For example, Short Message Service (SMS) or other suitable messaging services may be used to transmit the serial numbers or other information that identifies the documents without having to manually input the serial numbers or other identifying information using a keyboard or other manual input device on the mobile or cellular telephone. In one implementation, the mobile or cellular telephone may include one or more optical character recognition (OCR) components that can extract the serial numbers from photographs or other images that the camera captures from the documents.

According to one aspect of the invention, the system and method described herein may then compare the serial numbers or other information that identifies the currency documents to a list that resides locally on the mobile or cellular telephone, at a data processing facility, or another suitable location. In particular, the list may include information that identifies invalid currencies, counterfeit currencies, or other currencies known to be associated with criminal activities (e.g., drug trafficking, money laundering, terrorism, kidnapping, theft, robbery, corruption, etc.), whereby the currency documents may be deemed invalid in response to the serial numbers or other identifying information extracted with the mobile or cellular telephone matching any of the identifying information in the list. Accordingly, the system and method described herein may validate, trace, and track currency documents to prevent or otherwise detect currency documents used in criminal activities (e.g., the World Bank estimates that approximately $1 trillion is spent every year to bribe public officials, but corrupt individuals will obviously think twice before accepting bribes if they realize that bribe money is traceable). In one implementation, photographs, fingerprint images, or other biometrics may be obtained from individuals that used the invalid or wanted currency documents in addition to information read from drivers' licenses, license plates, passports, visas, student identification cards, or other identification documents, which may provide information that can help to later identify the individuals. Furthermore, in one implementation, global positioning system (GPS) coordinates or other location information for mobile or cellular telephones may be triangulated to track criminals (e.g., GPS coordinates for a mobile telephone may be identified at the scene of a bank robbery and then followed to apprehend the perpetrator). As such, the system and method described herein may capture various types of information associated with potential criminal activities, which may be linked and used together in investigations regarding the same.

According to one aspect of the invention, the system and method described herein may utilize any suitable mobile or cellular telephones, with or without cameras, having capabilities to send data using SMS messages or data connections and having sufficient memory to load suitable software that can read and authenticate currency serial numbers from temporarily stored images to prevent counterfeiting or otherwise combat cash-related crime. For example, in one implementation, the system and method described herein may obtain images of a currency document using a mobile or cellular telephone camera, capture a serial number of the currency document from the image, compare the captured serial number to various wanted serial numbers, and determine that the currency document has been used in unlawful or otherwise criminal activity in response to the serial number matching any of the wanted serial numbers. In one implementation, the software may further enable the serial number to be manually input to combat crime with any mobile telephones that lack cameras. Further, in one implementation, the serial number captured with the mobile or cellular telephones may be associated with a tag that identifies a money exchange transaction in which the currency document was used, wherein the image of the currency document or the serial number on the currency document may be obtained when the money exchange transaction occurs. The serial number may then be communicated to a local or remote data repository, which may receive and store captured serial numbers from various sources. As such, the serial numbers stored in the data repository may be analyzed to identify duplicate serial numbers, which may indicate likely counterfeit activity or other potentially fraudulent or criminal activities.

Other objects and advantages of the invention will be apparent to those skilled in the art based on the following drawings and detailed description.

### BRIEF DESCRIPTION OF THE DRAWINGS

FIG. 1 illustrates an exemplary overview of the systems and methods for utilizing mobile telephones to combat crime described herein, according to one aspect of the invention.

FIG. 2 illustrates an exemplary method for reading and authenticating currency serial numbers to combat crime, according to one aspect of the invention.

FIG. 3 illustrates an exemplary system for utilizing mobile telephones to combat crime, according to one aspect of the invention.

FIGS. 4-5 illustrate exemplary methods for configuring and utilizing mobile telephones to combat crime, according to one aspect of the invention.

FIG. 6 illustrates an exemplary system for triangulating mobile telephones to combat crime, according to one aspect of the invention.

FIG. 7 illustrates an exemplary data structure that can be used to combat crime with mobile telephones, according to one aspect of the invention.

### DETAILED DESCRIPTION

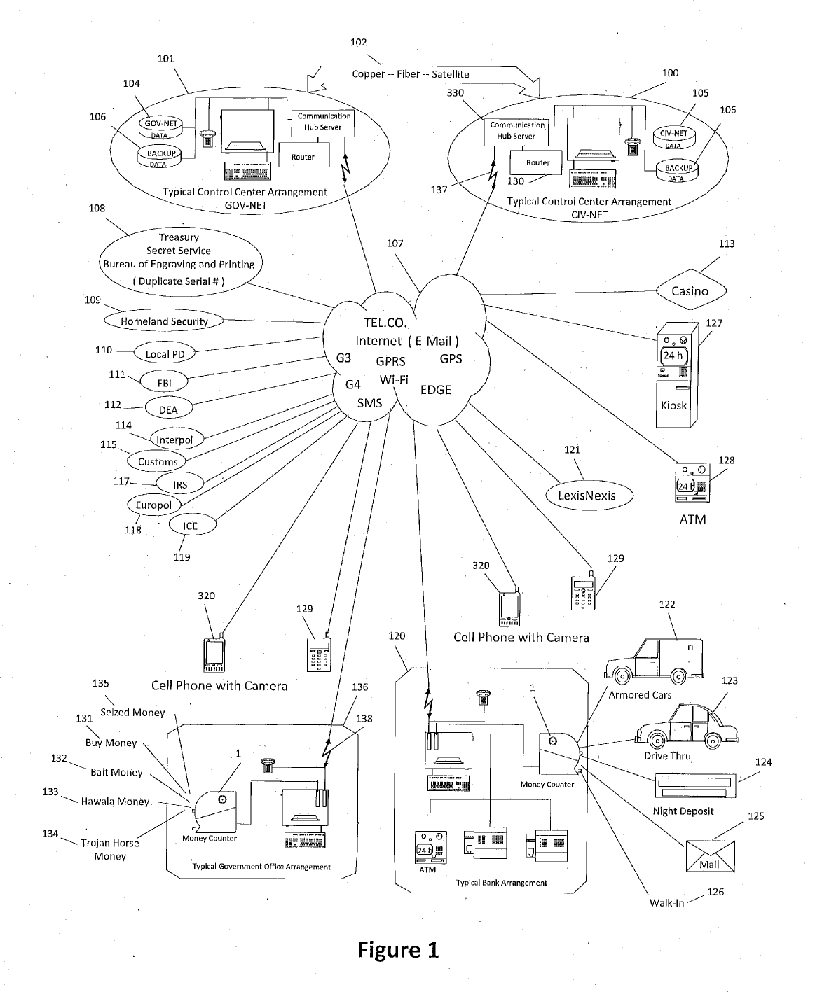

According to one aspect of the invention, FIG. 1 illustrates an exemplary overview of the systems and methods described herein, which may utilize mobile telephones in various ways to combat crime. In particular, presently banks 120 and government offices 136 operate the same way internationally and primarily exist to accept money deposits through various methods, including armored cars 122, drive-through tellers 123, night deposits 124, via mail 125, walk in 126, and any other feasible way. In many money deposit scenarios, a money counter 1 typically counts the money to be deposited, and in response to the depositary financial institution verifying that the count from the money counter 1 correctly matches an amount stated in the deposit, the depositary financial institution then appropriately credits an account associated with the depositing entity. This universal deposit procedure remains the same with the addition of serial number reading capabilities associated with the money counter 1, which generally uploads serial number data read with the money counter 1 to a control center 100 and 101 (e.g., a government control center and a civilian control center) through a communication cloud 107.

In one implementation, the control center 100 may generally include, among other things, a router 130, a communication hub server 330, a communication link 137, a civilian network data repository 105, and one or more appropriate backup network data facilities 106, and the control center 101 may similarly include a router, a communication hub server, a communication link, a government network data repository 104, and one or more appropriate backup network data facilities 106. Furthermore, the control centers 100 and 101 can be connected to one another (or other similar control centers) through direct link of copper wires 102, fiber optics 102, satellite communications 102, or other communication mechanisms 102. In one implementation, although the system shown in FIG. 1 separates governmental data input sources 136 from the civilian network and includes a separate governmental control center 101, the governmental data input sources 136 and governmental control center 101 may be suitably combined with the civilian network, or other suitable arrangements may be used. In one implementation, many other interested parties (e.g., the Treasury, Secret Service, Bureau of Engraving and Printing 108, etc.) can connect to the control center 101 through a telephone company communication cloud 107, whereby the other interested parties can communicate with the control center 101 to exclusively search for duplicate serial numbers. For example, Homeland Security 109, local police departments 110, FBI 111, DEA 112, Interpol 114, Customs 115, IRS 117, Europol 118, ICE 119, and any other interested agency can access databases associated with the control center 101. Additionally, other systems and devices can suitably upload information to the control center 101. In one implementation, the information uploaded to the control center 101 through at least one typical government office arrangement 136 can be from different sources, which may include seized money 135, “buy” money 131, bait money 132, Hawala money 133, Trojan Horse money 134, or any other source having suitable interest to the government. In one implementation, the government office 136 may obtain the information to be uploaded to the government control center 101 via the money counter 1 and then upload such information to the government control center 101 through a communication link 138. The government control center 101 may therefore receive the information uploaded from the typical government office arrangement 136 and store the received information in the government data repository 104 and maintain a backup in the backup data facility 106.

In one implementation, the typical bank arrangement 120 may be connected to the civilian control center 100 via the communication cloud 107 in various communication systems (e.g., the Internet, G3, G4, GPS, GPRS, Wi-Fi, EDGE, SMS, MMS, or any other currently available or future-developed communication protocol). The information received from the typical bank arrangement 120 may originate from various sources, which may include Cash In Transit companies (armored cars) 122, drive thru tellers 123, night depositories 124, mail deposits 125, walk-in bank transactions 126, or any other source that may presently exist or arise in the future). In one implementation, these sources may all generally receive currency, which may be counted with a money counter 1 that can verify the deposit amount associated therewith, and at substantially the same time, read serial numbers from the banknotes and upload the information to the civilian control center 100. In addition, the civilian control center 100 may further receive information uploaded from other non-governmental sources in a substantially similar manner, wherein such other non-governmental sources may include gaming establishments 113, unattended banking kiosks 127, ATMs 128, LexisNexis 121, mobile or cellular telephones without cameras 129, and mobile or cellular telephones with cameras 320. Thus, the serial number information obtained in this manner can be stored in appropriate databases and compared to lists of “wanted” serial numbers identified as potentially being involved in criminal activity. For example, to identify currency that may potentially be involved in criminal activity, mobile and cellular phones 129 and 320 can query the databases to search for the “wanted” serial numbers. Furthermore, in one implementation, in response to finding the “wanted” currency in the databases, the control center 100 may return a coded message to the querying mobile and cellular phones 129 and 320 to protect security for the information transmitted therein.

In one implementation, as described in further detail in U.S. patent application Ser. No. 11/819,887, now U.S. Pat. No. 7,567,698, which was been incorporated by reference above, the money counter 1 may generally read and authenticate serial numbers on currency documents that pass through the money counter 1. In particular, the money counter 1 may accept one or more currency documents along a longer dimension of the currency documents, whereby the currency documents may pass through the money counter 1 in a shortest possible path to allow faster counting operations. For example, the currency documents may rest on a plate in the money counter 1, which may be disposed between one or more money guides. In one implementation, one or more wheels that rotate along respective axles may assist in advancing the currency documents into the money counter 1. In one implementation, the wheels may be constructed from plastic or another suitable material, and a softer material may cover an outer portion of the wheels (e.g., a pliable plastic or another soft material). In one implementation, the outer portion of the wheels may typically be longer than a length of the currency documents, such that every full turn of the wheels may push an adjacent one of the currency documents into the money counter 1. Thus, due to the longer circumference of the wheels relative to the length of the currency documents, a space may exist between each of the currency documents, which enable the money counter 1 to separately and accurately count the currency documents.

In one implementation, as the currency documents pass through an opening of the guide, the currency documents reach another wheel that rotates around an axle. The opening may allow multiple currency documents to pass through the guide, and the currency documents may stop or otherwise register at an edge of a raffle wheel that rotates along an axle. In one implementation, the raffle wheel may remain stationary rather than rotate in order to stop movement of the currency documents. Thus, various currency documents can register at an edge of the other wheel and the raffle wheel one at a time, thereby forming a stack of currency documents. In one implementation, a softer portion of the wheel may aid a bottom currency document in the stack to enter into the money counter 1. For example, subsequent to a soft portion of the wheels pushing the currency document through the opening, the soft portion of the wheel can pick up the bottom currency document in the stack and push the currency document through the money counter 1. Thus, because the raffle wheel can ensure that the currency documents pass through the money counter 1 one at a time, the currency documents remaining in the stack may stay in the registered position for at least one full revolution of the wheels. The currency document being counted then follows a counting path through the wheels prior to registering in a position where a stacker wheel rotates around an axle to push the currency document into a stacker prior to the currency document being counted. During that time, the currency document can be counted and the currency document may pass through several sensors that enforce security measures (e.g., checking for watermarks).

In one implementation, while the currency documents in the stack remain in the registered position, the bottom currency document remains stationary between the raffle wheel and the wheel that aids the bottom currency document into the money counter 1 until the aiding wheel finishes a full rotation. While the currency document remains stationary (i.e., prior to being counted), a camera or other image capturing device may capture a photograph or other image of the currency document through a window. In one implementation, the camera may be fastened to a bracket and aimed at a mirror that can reflect or otherwise display the image of the bottom currency document through the window. In one implementation, an “interrupter finger” may be attached to the axle of the wheels and rotate together with the axle, wherein once per revolution of the axle, the interrupter finger may pass through an optical interrupter fastened to a bracket. In response to the optical interrupter triggering, a circuit coupled to the optical interrupter may cause the camera to capture the image from the bottom currency document in the registered position (e.g., from the reflected image in the mirror). In one implementation, the image may be captured subsequent to the entire currency document passing through a counting space, and prior to the soft portion of the wheels pushing the currency document out of the registered position. As such, the image may be captured from stationary currency documents, prior to the currency documents entering the money counter 1 for counting, to ensure optimal conditions for a clear and high-quality image. However, it will be apparent that other suitable arrangements can be used, such as capturing the image after a counting cycle ends (e.g., when the currency document exits the counting portion). Furthermore, in one implementation, the camera may be a high-quality camera that can capture high-resolution images (e.g., raw data) and capture a substantial number of images in a short time frame (e.g., twenty or more images per second). For example, the camera may capture a similar number of flaps per second (fps) as a video camera, which can typically take approximately thirty fps. Moreover, it will be apparent that such an approach can work with other types of counters (e.g., feeding from the top of the money stack, in which case the camera may capture the image of the top currency document prior to entering the counting portion of the money counter 1).

In one implementation, the money counter 1 may be fitted with the bracket fastened to the plate, and the currency documents may rest on top of the wheels. In one implementation, the wheels may then rotate via axles, wherein a pulley gear attached to the axles may provide power driving the axles and the rotation of the wheels. in one implementation, the currency documents may be placed face-down and head-first to ensure that serial numbers on an upper left side of the currency documents will be visible for the camera to capture the image of the serial numbers from the currency documents, wherein the image of the serial numbers may be captured with the camera in response to the interrupter finger passing through the interrupter sensor.

In one implementation, a portion of the currency documents may be illuminated using light emitting diodes (LEDs) to improve lighting and ensure an optimal quality for the image. In one implementation, a light intensity of the LEDs may be controlled with one or more resistors. In particular, photographing an object positioned very close to the camera may require use of a wide-angle lens or “fisheye” lenses, but wide-angle lenses typically have a picture distortion element that tends to cause the center of the image to be brighter than the edges. As such, the LEDs may be positioned or otherwise designed to illuminate the currency document with a diffused and uneven light (e.g., to compensate for “fisheye” effects of a camera lens), whereby the light may be brighter on the edges and darker in the center. For example, various different illumination levels may be used (e.g., three) depending on a geometry of the lens. Furthermore, to account for many commercially available LEDs having a water clear color and a dome tip to better concentrate emitted light, the tips may be removed from the LEDs (e.g., via a grinding process). As such, removing the tips from the LEDs may avoid spot light points and ensure that the light emitted from the ends will be diffused. It will be apparent, however, that specially constructed LEDs that emit diffused light may be used.

In one implementation, the money counter 1 may employ an optical sensor installed in the plate. Thus, when the currency documents have been placed on top of the plate, the sensor may trigger the counting process, which may be monitored at a control panel. In one implementation, the camera may then be triggered in response to the sensor covering the currency documents (e.g., in response to the interrupter finger passing through the interrupter). In response to the final currency document passing through the money counter 1 and the photo sensor then becoming uncovered, an enable signal would no longer be provided to the camera and the interrupter finger would no longer trigger the camera to capture images because no currency documents remain to be counted. In one implementation, the enable signal from the photo sensor may further signal the LEDs to turn on, and in response to the currency document no longer covering the sensor, the enable signal may be cut-off to signal the LEDs to turn off.

It will be apparent that the sequence described above can be entirely mechanical or controlled with a microprocessor control system. For example, a controller or other control system may be implemented to perform other related tasks and provide additional functionality (e.g., adjusting an intensity of light used to illuminate the currency documents). For example, the controller, microprocessor, or other software routine can be used to control current that drives through the resistors, which can turn on the LEDs every time a currency document comes into position (e.g., creating a strobe effect for better and crisper images). For instance, crisper images or pictures may simplify optical character recognition (OCR) or other techniques that may be used to capture serial numbers from the currency documents. However, the process that captures the serial number should be as fast as possible because certain money counting machine may pass currency documents through the image-capture portion quickly. Thus, in one implementation, the microprocessor control system may translate the image to an American Standard Code for Information Interchange (ASCII) serial number to enable quickly comparing the number to various sources that list wanted or otherwise fraudulent serial numbers (e.g., serial numbers involving illegal activities). For example, the currency documents may be validated and authenticated based on a uniqueness of the serial numbers captured from the currency documents, wherein duplicate serial numbers may be relevant to deterring or detecting counterfeit currency documents.

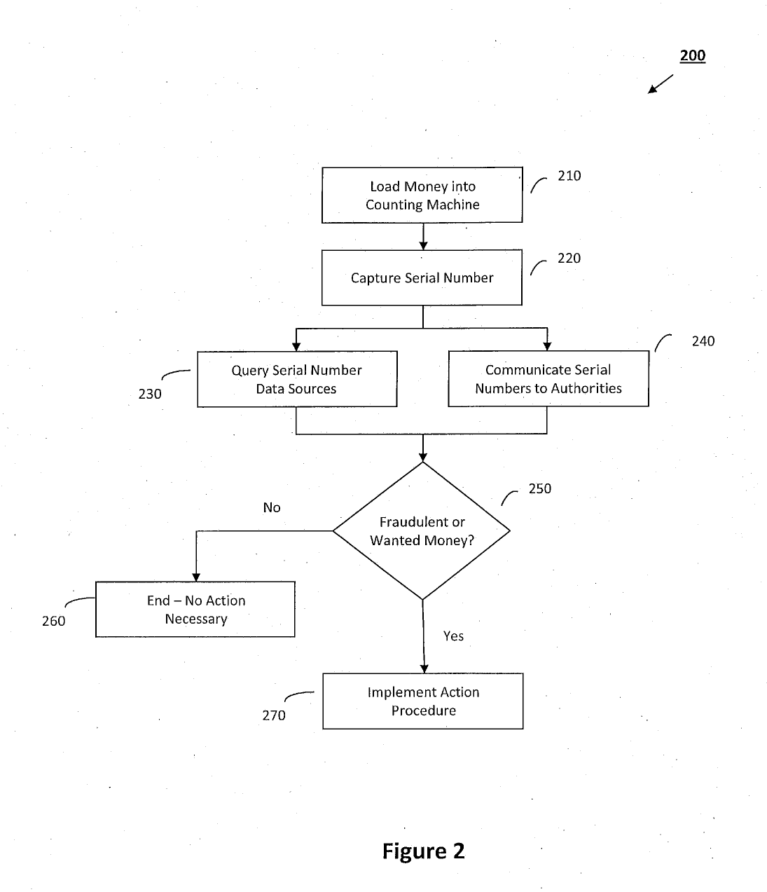

According to one aspect of the invention, FIG. 2 illustrates an exemplary method 200 for reading and authenticating currency serial numbers to combat crime. In particular, the method 200 may be performed in a system that includes a money counter that can capture or otherwise read serial numbers from currency documents that pass through the money counter. For example, the money counter may include a mechanism that can attach or other fit an add-on device that can read and authenticate serial numbers from currency that passes through the money counter, or new money counters that employ similar features or components that can capture serial numbers from currency documents can be suitably designed.

In one implementation, an operation 210 may include loading money to be counted into a money counter that can capture a stationary picture or image of the money prior to individual currency documents entering the counting section of the money counter. As such, an inexpensive, ordinary camera can be used to capture a serial number of the currency in an operation 220. In one implementation, having the currency remain stationary during operation 220 may avoid a need to employ expensive cameras that capture images “on the fly” with expensive stroboscopic lights. However, such cameras may nonetheless be used to improve a quality of the image captured in operation 220, and the method 200 may be used to capture serial numbers or other identifying information from any suitable currency regardless of shape, size, or language. In one implementation, in response to capturing the serial number in operation 220, the captured serial numbers may be associated with tag or file that attaches identification information to the serial number (e.g., a transaction time, a point of sale location, or any other information that appropriate authorities deem valuable).

In one implementation, the captured serial number may then be queried against various currency databases in an operation 230 and provided to appropriate authorities for comparison against available lists of wanted money in an operation 240. For instance, an exemplary scheme that targets criminal activity may involve authorities tagging wanted money to catch criminals or other perpetrators (e.g., scanning money allocated to be used as “buy money” or “Trojan horse” money). In particular, police officers, law enforcement officers, or other suitable authorities may designate an agent to use the scanned “buy money” in an undercover drug deal, a sting operation, or other criminal activity, wherein subsequent to the agent using the buy money in the designated criminal activity, the criminal will likely then use the “buy money” to purchase products from various points of sale (e.g., a gasoline station). The point of sale may further employ closed-circuit television surveillance systems (e.g., to provide security) and deposit daily cash proceeds directly to a financial institution (e.g., through an armored car service or otherwise). Thus, to credit the depositors' account for the deposited cash proceeds, the financial institution receiving the deposit may pass the currency through a Reading and Authentication Device (RAD) to verify a deposit amount and capture serial numbers and transaction data from the deposited currency. Furthermore, storing the serial numbers may protect banks and, other financial institutions from armed robberies because the currency may be easily located when the currency passes through a RAD at another point-of-sale.

In one implementation, the financial institution or other suitable entity may therefore transmit the data to the proper authorities in operation 240, either automatically or manually, and in response to the authorities detecting the “buy money” among the deposited funds (e.g., in an operation 250), the authorities may implement an appropriate action procedure in an operation 270 to apprehend the person that used the “buy money.” For example, the action procedure implemented in operation 270 may include acquiring closed-circuit television surveillance tapes, DVDs, or other recordable media from the point-of-sale using the transaction identification information and analyzing the surveillance tapes, DVDs, or other recordable media to identify the person that used the “buy money.” Furthermore, the authorities or point-of-sale may send the data to a centrally located data processing facility, which may also receive data from other locations. The data processing facility may cross-check the data to determine whether the currency includes any indicators of fraudulent activity (e.g., duplicate serial numbers, money used in armed robberies, extortion, terrorism, money laundering, or other illegal schemes, etc.). In response to detecting any fraudulent activity, the authorities may then take any appropriate or necessary action in operation 270. For example, a point-of-sale RAD or a mobile or cellular telephone may be used at any point-of-sale that has received fraudulent or wanted money, and video, voice, or other recording devices may be deployed to automatically initiate recording patrons in response to detecting any potentially fraudulent or wanted money in subsequent operations 250.

For example, in one implementation, the mobile or cellular telephone may include software that interacts with a video camera or other video functionality associated therewith to record video relating to the transaction, including currency documents or negotiable instruments exchanged in the transaction and identification documents (e.g., a driver's license, license plate, passport, visa, student identification card, etc.) associated with an individual that used the currency documents or negotiable instruments exchanged in the transaction. The mobile or cellular telephone may then send a message that includes the recorded video to the control center via Bluetooth, Multimedia Messaging Service (MMS), or another suitable communication protocol and receive one or more Bluetooth messages, MMS messages, or other suitable messages from the control center that include feedback on the documents recorded in the video. Moreover, in one implementation, the software may interact with the video camera or other video functionality associated with the mobile or cellular telephone to record the events associated with the transaction, including any events that relate to detaining or arresting the individual, thereby documenting evidence that may assist law enforcement investigations relating thereto and/or defend against any adverse claims that the individual may raise (e.g., unlawful detention, false arrest, use of excessive force or brutality, etc.).

The techniques described herein to read and authenticate serial numbers captured from currency documents may have broad applicability to combat crime, including the ability to detect “Supernotes” or penetrate various money exchange schemes. For example, a centuries-old currency exchange system, Hawala, includes transferring money from place to place outside of a legitimate banking system. The Hawala system tends to be very popular in money laundering, drug trafficking, terrorist financing, and other criminal schemes. Thus, the techniques described herein may be used to penetrate Hawala schemes in contexts where an undercover agent may seek a Hawaladar (i.e., a money launderer) in order to send money to another undercover agent in a remote location (e.g., the “Trojan Horse Scheme”). In particular, the sending undercover agent hands previously scanned money to the Hawaladar, who typically collects a commission and communicates with another Hawaladar that hands a different batch of currency to the receiving agent. This process may be repeated several times, using an adequate amount of money each time, with only the cost to law enforcement officers or taxpayers being the commission paid to the Hawaladars. As such, the Hawaladars will likely eventually use the currency with recorded serial numbers to serve other customers, and the currency will eventually be utilized to buy groceries, gasoline, and other products from a point-of-sale that has installed a RAD, or is using a mobile telephone 320, in communication with the central data processing facility, the appropriate authorities, or other suitable entities, which may provide information that can be used to identify the Hawaladars' customers (i.e., criminals or others likely to launder money).

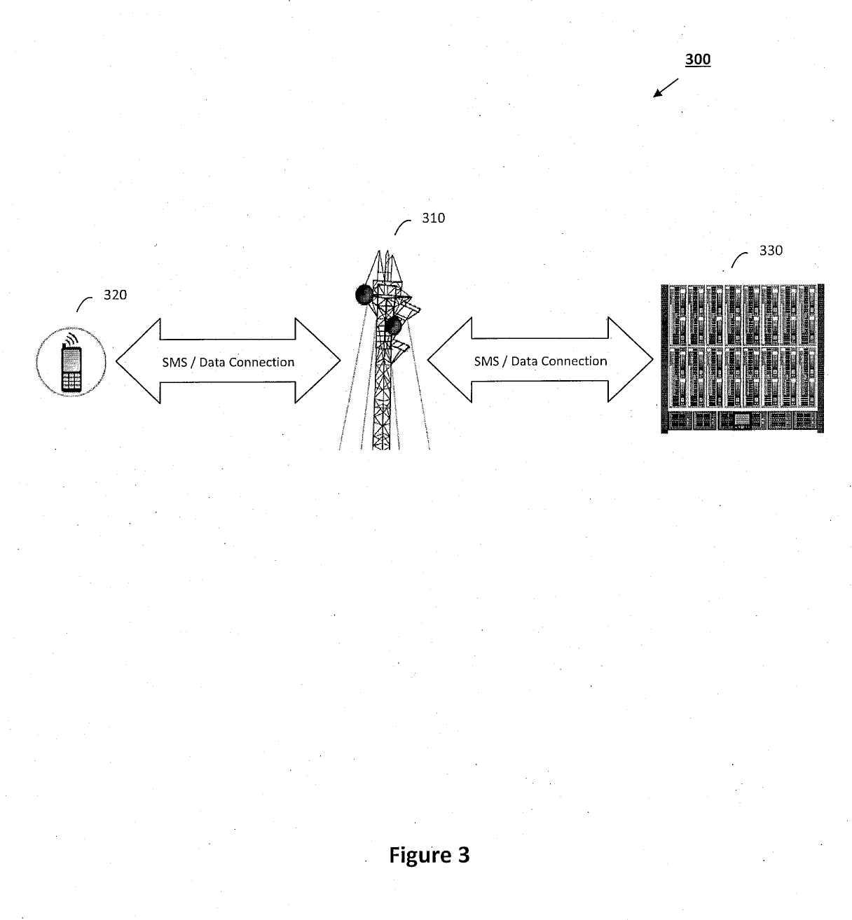

According to one aspect of the invention, FIG. 3 illustrates an exemplary system 300 for utilizing mobile telephones to combat crime. In particular, the system 300 shown in FIG. 3 may provide a capability to scan any suitable currency in any worldwide location, wherein increasing a number of banknotes that the system 300 scans and prepares may increase a likelihood that the system 300 will find “wanted” banknotes. For example, in one implementation, the system 300 may utilize any suitable mobile or cellular telephone 320 that can send data using SMS messages or over an appropriate data connection, and that further have sufficient memory to load and execute appropriate software that can read and authenticate serial numbers from images of currency document temporarily stored on the mobile or cellular telephone 320. Further, the software that reads and authenticates the serial numbers may be installed or otherwise loaded on the mobile or cellular telephone 320 in various ways. For example, the mobile or cellular telephone 320 may have the software pre-installed or otherwise pre-loaded prior to sale to a consumer, downloaded and installed from a mobile application store or other similar source post-sale, and/or downloaded and installed from a website or other suitable location provided by a particular vendor. Additionally, the software on the mobile or cellular telephone 320 may scan or read various other documents that may be susceptible to fraud or otherwise involved in criminal activity (e.g., negotiable instruments, drivers licenses, license plates, passports, visas, student identification cards, etc.). As such, to the extent that any description provided herein relates to currency documents, it will be understood that such description may be suitably applied in a substantially similar manner to negotiable instruments, drivers licenses, license plates, passports, visas, student identification cards, or any other document that may relate thereto (e.g., the mobile telephone 320 may capture information relating to other document types suspected to be involved in criminal activity, or information relating to drivers licenses or other suitable document types that may be used to identify a particular individual associated with the suspect documents).

In one implementation, to identify currency that has been used in unlawful activity, the mobile telephone 320 may obtain an image of a currency document using a camera located on the mobile telephone 320, and the mobile telephone 320 may then capture a serial number of the currency document from the image (e.g., using optical character recognition techniques). In one implementation, the serial number captured from the currency document may then be compared to various wanted serial numbers, wherein the currency document may be deemed to have been used in criminal activity in response to the captured serial number matching any of the wanted serial numbers. In one implementation, the mobile telephone 320 shown in FIG. 3 may include any suitable mobile telephone 320 having the capabilities mentioned above, including currently available and future-developed mobile telephones 320. For example, the current generation of mobile telephones 320 typically include one or more cameras, global positioning system (GPS) sensors, GPRS, EDGE, 3G or 4G, and Wi-Fi networking capabilities, and expandable memory, which typically provide sufficient capabilities to read and authenticate serial numbers from currency documents with the techniques to be described in further detail herein. For example, in one implementation, the mobile telephone 320 may contact a server 330 to download software that would then be transmitted to the mobile telephone 320 (e.g., through one or more mobile or cellular telephone 310 towers). In response to installing and executing the software downloaded from the server 330, the software may use the camera on the mobile telephone 320 to capture images of currency bills, perform optical character recognition on the captured images to capture the serial numbers from the currency bills, and then transmit the serial numbers to the server 330. As such, downloading and executing the software on the mobile telephone 320 would immediately convert the mobile telephone 320 into a Reading and Authentication Device (RAD).

In one implementation, one or more lists may contain information identifying the various “wanted” serial numbers, wherein the lists may reside on the mobile telephone 320 or at a data processing facility associated with the server 330. Further, in one implementation, the serial number captured from the currency document may be associated with a tag that attaches information identifying a money exchange transaction that involved the currency document, wherein the image may be captured or the serial number obtained when the money exchange transaction occurs. For example, in one implementation, the money exchange transaction may occur at a point of sale (e.g. a retail establishment, restaurant, bar, gas station, etc.), at a bank or other financial institution that processes the currency document, or at any other suitable location. In one implementation, the serial number may then be communicated to a local data repository on the mobile telephone 320. Alternatively (or additionally), the serial number may be communicated to a data repository located at the server 330, wherein the server 330 may store captured serial numbers from various sources. In one implementation, the serial numbers in the local or remote data repository may then be analyzed to identify any duplicate serial numbers, which may indicate likely counterfeiting activity, or to otherwise identify information indicating that the currency document was potentially used in fraudulent or criminal activities.

Furthermore, in one implementation, a user of the mobile telephone 320 may purchase a typical RAD system (e.g., a currency counter and laptop), which may allow large volumes of currency serial numbers to be captured and transferred with high speed components (e.g., as described in further detail above in connection with FIG. 1). Thus, any users having a RAD system may then transfer wanted serial numbers and captured serial numbers between the RAD and the mobile telephone 320, wherein having the ability to convert and suppress data needed to transfer serial numbers to the central data processing facility 330 can allow the system 300 to operate extremely fast and more economically than any existing system. For example, GSM-capable mobile telephones 320 may send to the server 330 up to ten SMS messages (or two-hundred serial numbers) per minute, which may increase to twenty SMS messages (or four-hundred serial numbers) per minute with GPRS-capable mobile telephones 320. Thus, because an image of the serial number would be approximately four-hundred kilobits, a mobile telephone 320 transmitting the entire image using a 4G data connection could send to the server 330 approximately fifteen images per minute. Alternatively (or additionally), sending only the digitized numbers may enable the mobile telephone 320 to convert a four-hundred kilobit image into forty-seven bits and thereby transmit approximately twenty thousand serial numbers to the server 330 every second (or twenty serial numbers, each having eleven digits, per SMS message).

In one implementation, the server 330 may generally be housed in a secure facility that only provides highly restricted access to the server 330 and any rooms that house the server 330. Furthermore, the server 330 may be configured with redundancy and have data replicated across multiple servers to ensure that the system 300 will have high availability. For example, the facility housing the server 330 may include redundant power supplies, battery backup systems, and diesel generators that can provide consistent power to the server 330 even during power outages. Furthermore, various network connections that provide communication between the server 330 and external communication gateways 310 may have redundancy, with multiple service providers guaranteeing availability (e.g., pursuant to service level agreements with the service providers). In one implementation, various firewalls, intrusion detection systems, and other security systems may be used to secure any networks that communicate data to or from the server 330, intrusion detection systems, and the server facility 330 may include local and remote monitoring systems designed to ensure that the server facility 330 operates continuously and with high availability. In one implementation, the server facility 330 may further periodically backup data to offsite data repositories provide disaster recovery or fault tolerance capabilities.

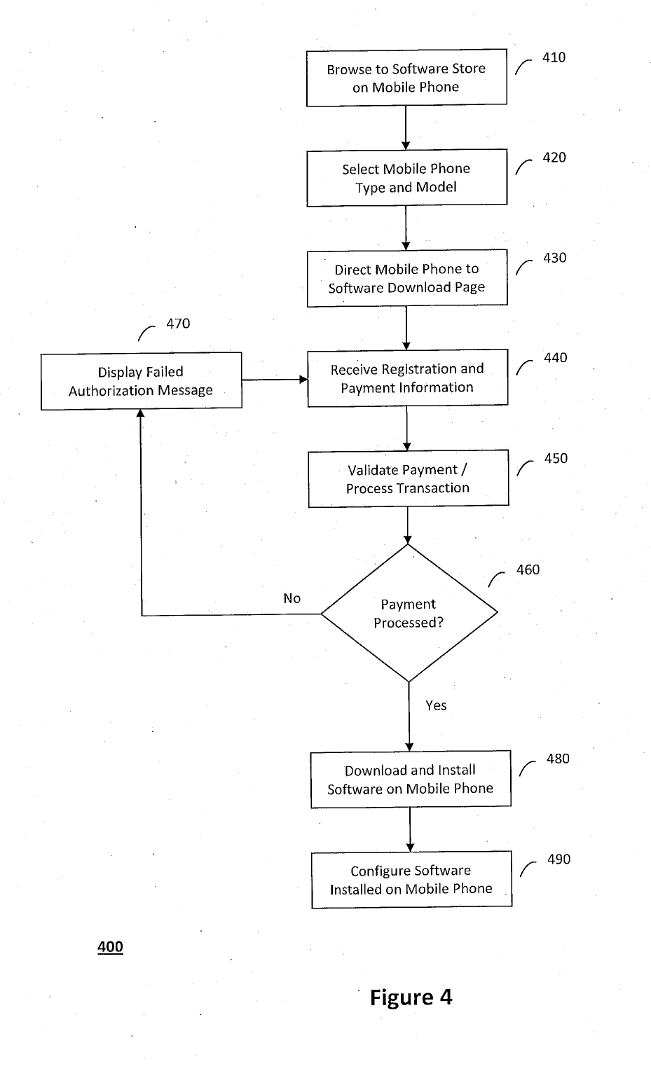

According to one aspect of the invention, FIG. 4 illustrates an exemplary method 400 for configuring and utilizing mobile telephones to combat crime. In particular, the method 400 shown in FIG. 4 may include a mobile telephone client browsing to an appropriate software store in an operation 410 (e.g., using a standard mobile telephone web browser). In one implementation, an operation 420 may then include a user of the mobile telephone selecting a type of the mobile telephone from a list, and the web browser on the mobile telephone may then be directed to an appropriate download page in an operation 430. In one implementation, the user may then fill in a registration form in an operation 440, wherein the registration form may include details such as a name of the user, a phone number for the mobile telephone, an Electronic Serial Number (ESN) that uniquely identifies the mobile telephone, and credit card or other payment information. In one implementation, operation 440 may further require the user of the mobile telephone to accept an End User License Agreement (EULA) that sets forth various terms and conditions for downloading the software that will convert the mobile telephone into a RAD.

In one implementation, an operation 450 may then validate the credit card or other payment information received in operation 440, wherein the mobile telephone may be provided with a link to download the software in response to determining that the payment has been suitably processed in an operation 460. Alternatively, in response to operation 460 determining that the payment could not be suitably processed (e.g., because the credit card was declined), an operation 470 may display a failed authorization message on the mobile telephone and provide the user with various options to resolve any issues that resulted in the failed authorization. In one implementation, in response to operation 460 determining that the payment was suitably processed, the software may be downloaded and installed on the mobile telephone in an operation 480. In one implementation, the user may then be required to accept the EULA (if the user did not previously accept the EULA), and various preferences may then be defined to configure the software on the mobile telephone in an operation 490. For example, in one implementation, the preferences that defined in operation 490 may include, among other things, any constraints or criteria associated with using a data connection or SMS on the mobile telephone, whether data should be uploaded and downloaded automatically or manually, whether to share information associated with a location of the mobile telephone, whether to receive notifications from the server in response to the server or other mobile telephone users finding wanted serial numbers, and whether to share contact information in response to the server or other mobile telephone users finding wanted serial numbers.

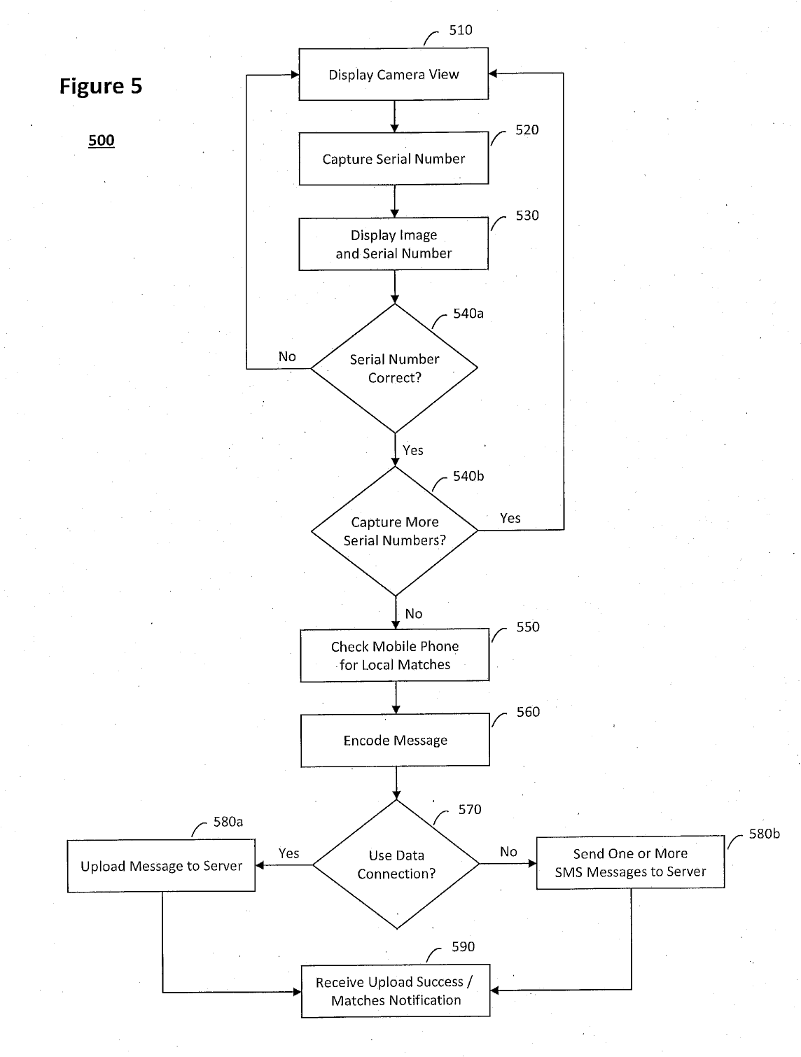

According to one aspect of the invention, FIG. 5 illustrates an exemplary method 500 for configuring and utilizing mobile telephones to combat crime. In particular, the method 500 shown in FIG. 5 may initially display a camera view on the mobile telephone in an operation 510 (e.g., in response to appropriately downloading the software to the mobile telephone with the techniques shown in FIG. 4 and described in further detail above). In one implementation, a user may then position the camera view on the mobile telephone to center a currency document serial number on a screen associated with the mobile telephone. In one implementation, an operation 520 may then include the user capturing a photograph or other image of the currency document serial number, wherein the photograph or other image may then be digitized using optical character recognition techniques. In one implementation, the digitized representation of the currency document serial number may then be displayed on the screen in an operation 530, and the user may be provided with an option to indicate whether or not the serial number was correctly captured in an operation 540a. In response to the user indicating that the serial number was not correctly captured, the method 500 may return to operation 510 to enable the user to attempt to capture a better photograph or image for the currency document serial number. Alternatively, in response to the user indicating that the serial number was correctly captured and accepting the image of the serial number, the user may be provided with an option to capture additional serial numbers in an operation 540b, wherein operations 510 through 540a may be repeated until the user has captured appropriate serial numbers from all relevant currency documents.

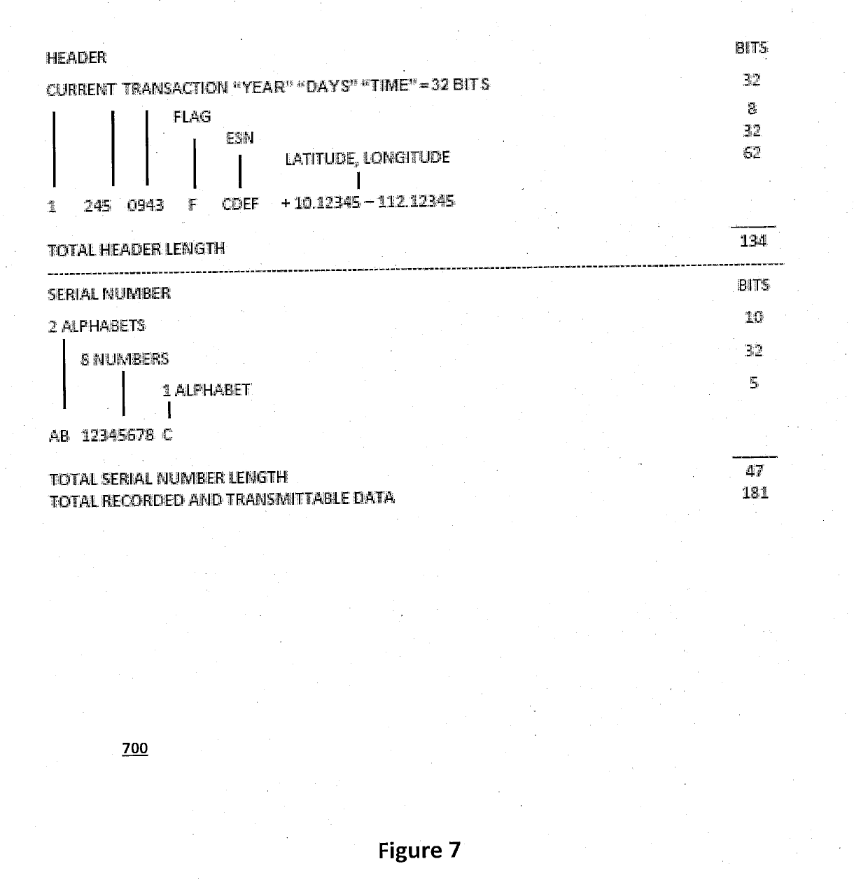

In one implementation, in response to the user indicating that all relevant serial numbers have been photographed or otherwise captured in operation 540b, the software loaded on the mobile telephone may save and upload the serial numbers. Furthermore, in one implementation, the software loaded on the mobile telephone may search any local repositories that include wanted serial numbers to check whether the serial number captured in operation 520 has any local matches on the mobile telephone. As such, in response to an operation 550 determining that the captured serial number has local matches on the mobile telephone, the matches may be displayed on the mobile telephone and a call to the control center 100 transmitting the matching numbers and the coordinates of the mobile telephone may be automatically initiated. Otherwise, no connectivity between the mobile telephone and control center may be necessary. In one implementation, an operation 560 may then encode the captured serial number and any matches identified in operation 550, wherein encoding the captured serial number and any identified matches in operation 560 may include encrypting the captured serial number and the identified matches and inserting a header to the data. For example, as shown in FIG. 7, the header may generally contain, among other things, an ESN associated with the mobile telephone, any available GPS coordinates or other location information, and years, days, times, or other suitable information to identify a transaction that involved exchanging the currency document. Thus, due to the small amount of data encoded with the header, encoding the message in operation 560 may enable the mobile telephone to transmit up to twenty serial numbers in a single SMS message. Furthermore, in, one implementation, the header encoded with the message that identifies the transaction may include times, dates, locations, or other suitable information that identifies the currency documents associated therewith, and for any currency documents that were deposited in a bank, the header may further include account information for an entity that deposited the currency documents in the bank. As such, encoding the message with the header may reduce a data size for the tags associated with the currency documents and consequently increase a number of currency document tags that can be included in the message and/or a speed associated with transmitting the message.

In one implementation, in response to suitably encoding the message, an operation 570 may include determining an appropriate technique to upload the message to the server. For example, in one implementation, operation 570 may include the user indicating whether to use SMS or a data connection to upload the message to the server, or the decision to use SMS or the data connection may be determined from previously established settings or based on automatically detected capabilities for the mobile telephone. For example, any mobile telephones that do not have an appropriate data plan may automatically send an SMS message to the server in an operation 580b, which may include encrypting and transmitting the data as SMS text. Furthermore, in one implementation, operation 580b may break the SMS message into smaller chunks that can be transmitted to the server in response to determining that the overall message includes an amount of data that exceeds the limits associated with SMS messages. In such a scenario, the server may reconstruct the message from the various chunks received from the mobile telephone. Alternatively, in response to the user selecting the option to use a data connection to upload the message to the server, the data may simply be uploaded to the server in an operation 580a (i.e., the data plan will typically not have any restrictions for an amount of data that can be transmitted, whereby the mobile telephone may continuously upload the data to the server until all the data has been received at the server). In another alternative, operation 570 may provide the user with an option to store the data locally and send the data to the server at a later time. In any of these scenarios, the message may include full serial numbers on the currency documents associated with the transaction described in the message, or may alternatively include partial serial numbers derived to uniquely represent the full serial numbers on the currency documents. In one implementation, using the partial serial numbers rather than the full serial numbers may increase speed and capacity associated with transmitting the message to the server (e.g., to obviate the need to break SMS messages into smaller chunks due to the data limits associated with SMS messages). Further, in one implementation, the software loaded on the mobile telephone may include a “kill switch” that can erase every serial number or associated data and uninstall or otherwise disable the program. For example, when a law enforcement officer may be under duress and forced to reveal his mobile telephone and any data that the mobile telephone contains, the kill switch may provide a potentially life-saving security feature.

In one implementation, in response to suitably transmitting the data to the server, an operation 590 may include the server determining whether the captured serial number matches any wanted lists, black lists, counterfeit lists, or other lists that include serial numbers associated with unlawful or otherwise criminal activity, or alternatively whether the captured serial number matches any serial numbers known to be valid. In one implementation, operation 590 may then further include the server informing the mobile telephone about whether or not the data was successfully received at the server and whether the captured serial number matches any of the wanted lists, black lists, counterfeit lists, or other lists that include serial numbers associated with unlawful or otherwise criminal activity, or alternatively whether the captured serial number matches any of the known valid serial numbers to verify the validity associated with the captured serial number. As such, the method 500 shown in FIG. 5 and described herein may provide anti-counterfeiting capabilities that may be used in various contexts. In particular, civilian, governmental, and military users may use image and video capture technologies associated with mobile telephones to capture images of banknotes and/or serial numbers and denominations associated with the banknotes. In a similar respect, civilian, governmental, and military users may use software associated with the mobile telephones to query a database that store the wanted lists, black lists, counterfeit lists, and/or valid serial number lists and receive a notification relating to the legitimacy associated with the banknotes, which may be particularly useful in countries or other locales having high volumes of counterfeit currency (e.g., India, China, etc.). In one implementation, all known United States banknote serial numbers can be stored in approximately five-hundred kilobytes, whereby a database storing all known United States banknote serial numbers may be sufficiently small to be downloaded and stored in the memory associated with the mobile telephones, which may enable the mobile telephones to verify the legitimacy associated with the banknotes locally without having to communicate with the server. Alternatively, the database may be centrally hosted at the server and not downloadable to address security concerns (e.g., to protect the serial number information stored therein against potential interception). Further, the anti-counterfeiting, capabilities need not be limited to mobile telephones, in that civilian, governmental, and military users may perform similar queries and receive similar notifications using desktop, laptop, tablet, or other computing devices.

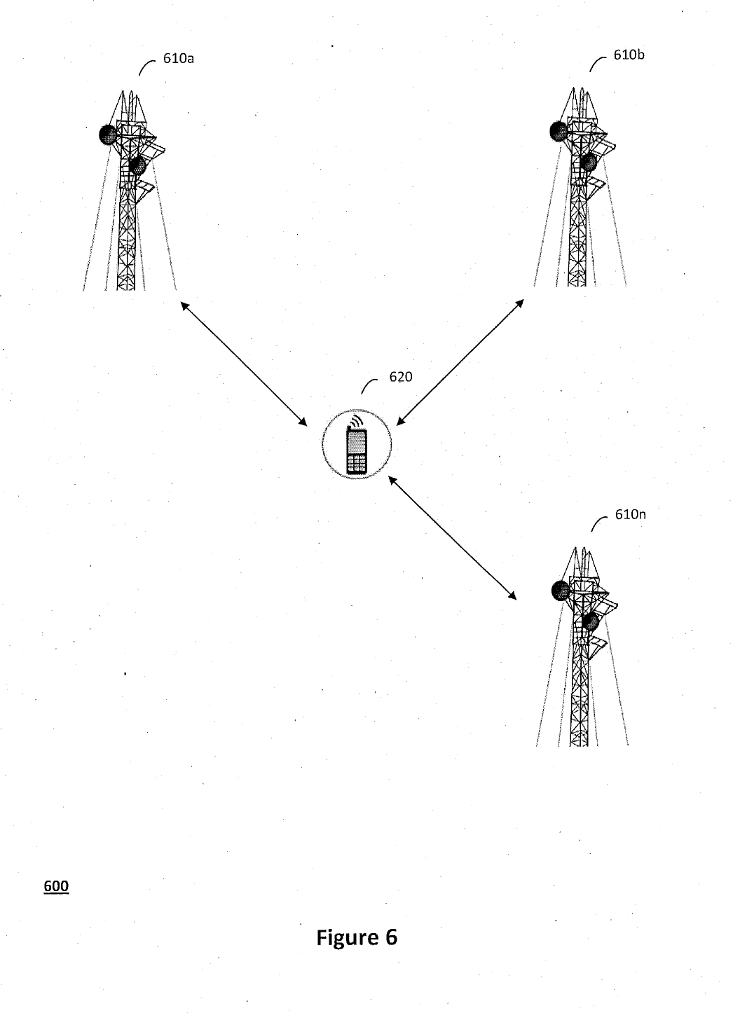

According to one aspect of the invention, FIG. 6 illustrates an exemplary system 600 for triangulating mobile telephones to combat crime. For example, the system 600 shown in FIG. 6 may generally triangulate signals from a mobile or cellular telephone 620 to prevent bank robberies, apprehend bank robbers, and otherwise track a mobile or cellular telephone 620 that may be associated with criminal activities. In particular, many (if not most) adults carry a mobile phone 620, and this assumption generally applies equally to bank robbers and other criminals. Thus, in one implementation, the system 600 shown in FIG. 6 and described in further detail herein may track a mobile or cellular telephone 620 that may belong to bank robber or criminal in order to track and apprehend the bank robber or criminal. For example, all mobile telephones 620 typically emit three types of mobile telephone signals, which include an Electronic Serial Number (ESN) signal, a Mobile Identification Number (MIN) signal, and a System Identification Code (SID) signal. In particular, the ESN signal uniquely represents the mobile telephone 620 with a unique thirty-two bit number permanently programmed into the mobile telephone 620 at a time of manufacture, the MIN signal includes a ten digit number derived from a phone number for the mobile telephone 620 and programmed into the mobile telephone 620 at a time of activation, and the SID signal includes a unique five digit number that the Federal Communications Commission (FCC) assigns to different carriers, which may be further programmed into the mobile telephone 620 at the time of activation. Thus, in one implementation, the ESN signal, the MIN signal, and the SID signal may uniquely identify the mobile telephone 620, an individual that owns the mobile telephone 620, and a service provider for the mobile telephone 620, which may collectively be used to track the mobile telephone 620 and consequently track the individual that owns the mobile telephone 620.

For example, as various patrons enter a bank lobby, a short range receiver located within the bank may record the MIN signals and the SID signals emitted from any mobile telephones 620 detected in the bank lobby, which likely belong to the patrons in the bank lobby. Furthermore, short range receiver located in the bank may further record a time and date when the detected mobile telephones 620 enter and exit the bank lobby (i.e., when any particular patron leaves the bank premises, the MIN and SID signals emitted from their mobile telephones 620 would no longer be visible to the short range receiver, and the short range receiver may therefore record such mobile telephones 620 as having exited the bank). Accordingly, in one implementation, the system 600 may generate a log that represents a “Time In” (in half-second increments) for any mobile telephones 620 that one or more receivers 610 detect, the MIN and SID associated with each of the mobile telephones 620 that the receivers 610 detect, and a “Time Out” (in half-second increments) for any mobile telephones 620 that the one or more receivers 610 no longer detect. In this manner, every signal from mobile telephones 620 visible to the receivers 610 may be logged in response to the individual owning or using the mobile telephone 620 entering the premises and one or more of the mobile telephones 620 may be logged out in response to the individual owning or using such mobile telephones 620 exiting the premises. Accordingly, in a typical bank robbery, a bank robber will enter the bank premises and approach the teller to demand cash, at which time the teller typically triggers a silent alarm. However, because the teller may be unable to safely trigger the alarm in certain scenarios (e.g., because the bank robber threatens the teller to not trigger the alarm at gun point), many banks configure a “money clip” to automatically trigger the alarm in response to the teller removing stolen money from the teller drawer. In one implementation, because the short range receiver 610 in the bank automatically logs every signal from mobile telephones 620 on the premises, any signals from a mobile telephone 620 that the bank robber may be carrying at the time of the bank robbery may be flagged, including any ESN, MIN, or SID signals that may have been recorded for such mobile telephones 620.

Furthermore, in one implementation, the cash given to the bank robber may have been “pre-tagged” (i.e., designated to be given to bank robbers), wherein pre-tagging the cash given to the bank robber may make the currency traceable. For example, the financial services industry typically operates in a manner whereby every teller working in a bank has in their possession a package of cash referred to as “bait money,” which generally includes various banknotes in previously prepared packages of mixed currency denominations with the bank documenting and retaining certain information that identifies the banknotes (e.g., the serial numbers and denominations) in a secure location. Thus, the teller typically knows to mix the bait money into any other money that the teller gives to a robbery suspect, wherein following a robbery, the information that identifies the banknotes in the bait money packages given to the robbery suspect may be provided to law enforcement agencies or other appropriate authorities to reference in efforts to investigate and ultimately apprehend and prosecute the suspects. However, current processes used to document the information that identifies the banknotes in bait money packages tends to be very labor-intensive and time consuming. In particular, typical techniques used to document such information include listing banknote denominations and corresponding serial numbers on a ledger sheet with teller identification numbers, bank branch names and branch numbers, or other information. Another technique often used to document the information that identifies banknotes in bait money packages includes entering banknote denominations and corresponding serial numbers into an electronic spreadsheet or database and associating the banknote denominations and serial numbers with the teller and bank identification information. Yet another technique often used to document this information includes photocopying or scanning every banknote in the bait money package and electronically storing the photocopies or scans with the teller and bank identification information.

In contrast, using the systems and methods described herein, any currency documents in the bank may essentially become bait money. For example, as described in further detail herein, rather than manually documenting and identifying banknotes in bait money packages, the system 600 may streamline and automate documenting and identifying the banknotes in bait money packages. In particular, the teller and bank identification information may entered into the system 600 and individual bait money packages may then be processed and prepared for every teller in the bank branch. For example, processing and preparing the bait money packages for every teller in the bank branch may generally include processing any banknotes on a currency counter in communication with the system 600, whereby denominations and serial numbers for the banknotes on the currency counter may be captured automatically (e.g., using the techniques described in further detail above in connection with FIG. 1 and FIG. 2). Thus, every bait money package may have information that uniquely identifies the banknotes included therein, which may tie the bait money packages to individual tellers.

Thus, in response to preparing the bait money packages for every individual teller, the denominations, serial numbers, or any other data recorded for the bait money packages may be stored on local computer hard drives at the bank and electronically transmitted to a server housed locally at the bank or a remote location that the bank employs to service various bank branches or locations. Additionally, the denominations, serial numbers, or other data recorded for the bait money packages may be electronically transmitted to a centralized server or database associated with the system 600, which may provide a backup for the data stored at the bank locations and further provide law enforcement officials with information that can be used to investigate and apprehend criminals in the event of a robbery. Furthermore, in one implementation, the bait money packages may include one or more headers that identify times, dates, locations, or other suitable information that identifies the banknotes included therein, and any bait money packages that include banknotes deposited in a bank, the headers may further identify account information for an entity that deposited the banknotes in the bank. As such, including the headers to identify the banknotes in the bait money packages may reduce a data size for the tags associated with the banknotes and consequently increase a number of banknote tags that can be included in any particular message and/or a speed associated with transmitting the message. In addition, as noted above, the message may include full serial numbers that identify the banknotes described in the message or partial serial numbers derived to uniquely represent the full serial numbers. As such, in one implementation, using the partial serial numbers rather than the full serial numbers may increase speed and capacity associated with transmitting the message to the server housed locally at the bank, the remote location employed by the bank, or the centralized server associated with the system 600.

In one implementation, authorized individuals may remove old batches of bait money packages from the bank and add new batches of bait money packages to the bank at any appropriate time. In particular, the authorized individuals may remove and add batches of bait money packages to the local computer hard drives and servers at the bank, which may further cause the servers or databases associated with the system 600 to update the backup for the data stored at the bank locations. As such, the information that identifies the banknotes in the bait money packages currently in use at the banks may be automatically updated to reflect a current inventory of bait money packages at every bank that uses the system 600, whereby the current inventory of bait money packages for every bank may be readily and instantaneously available for any suitable purpose (e.g., for internal audits, external audits, following a robbery, etc.). Additionally, in one implementation, the system 600 may link the serial numbers for the banknotes in the bait money packages to a limited number of mobile telephones 620 that were present in the bank lobby at the time of a robbery, wherein because bank robbers tend to commit robberies during time periods when few or no patrons are in the bank, linking the serial numbers to the mobile telephones 620 present in the bank lobby during the robbery may substantially narrow a scope of any efforts to pursue and apprehend the bank robber.

For example, in response to the bank robber leaving the bank, a location for the mobile telephone 620 may be tracked using triangulation via signals that various mobile telephone receivers 610 detect for the mobile telephone 620, wherein tracking the location for the mobile telephone 620 may further track the bank robber and the stolen money (assuming that the bank robber continues to carry the mobile telephone 620). In one implementation, the tracked location for the mobile telephone 620 may be transmitted throughout the system 600 in real-time in order to track suspected bank robbers or other criminals. For example, in one implementation, the located tracked from the triangulated signals detected from the mobile telephone 620 may be linked to a Google Maps application or another suitable application that provides location-based tracking capabilities (i.e., to pinpoint geographic locations that appropriate authorities can use to track the suspected bank robbers or other criminals). As such, the information may be used to locate the bank robber, whereby if and when appropriate authorities eventually apprehend the bank robber, the stolen money may be identified and recovered from the serial numbers that were previously linked to the mobile telephone 620 that was present in the bank during the robbery. Alternatively, the authorities may appropriately track the suspect indefinitely to investigate whether any additional suspects may be involved in the robbery (e.g., through direct contact observed in surveillance efforts, records associated with the mobile telephone 620, etc.). In another alternative, the authorities may appropriately track the suspect indefinitely to investigate whether the suspect uses the stolen money in any further criminal activities (e.g. laundering the stolen money, using the stolen money to buy drugs, or otherwise using the stolen money in other criminal efforts that can provide authorities with leads to investigate additional crimes).

Implementations of the invention may be made in hardware, firmware, software, or any suitable combination thereof. The invention may also be implemented as instructions stored on a machine-readable medium that can be read and executed on one or more processing devices. For example, the machine-readable medium may include various mechanisms that can store and transmit information that can be read on the processing devices or other machines (e.g., read only memory, random access memory, magnetic disk storage media, optical storage media, flash memory devices, or any other storage or non-transitory media that can suitably store and transmit machine-readable information). Furthermore, although firmware, software, routines, or instructions may be described in the above disclosure with respect to certain exemplary aspects and implementations performing certain actions or operations, it will be apparent that such descriptions are merely for the sake of convenience and that such actions or operations in fact result from processing devices, computing devices, processors, controllers, or other hardware executing the firmware, software, routines, or instructions. Moreover, to the extent that the above disclosure describes executing or performing certain actions or operations in a particular order or sequence, such descriptions are exemplary only and such actions or operations may be performed or executed in any suitable order or sequence.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

What is claimed is:

1. A system for utilizing mobile telephones to combat crime, comprising:
one or more data repositories configured to store a list that contains one or more wanted serial numbers; and
a server in communication with a mobile telephone, wherein the server includes one or more processors configured to:
receive a message from the mobile telephone, wherein the message includes information that identifies a serial number that the mobile telephone obtained from a financial document;
compare the serial number that the mobile telephone obtained from the financial document to the one or more wanted serial numbers; and
determine that the financial document may have been used in a criminal activity in response to the serial number that the mobile telephone obtained from the financial document matching any of the one or more wanted serial numbers.

2. The system of claim 1, wherein the mobile telephone executes software that converts the information that identifies the serial number into the message and suppresses the information that identifies the serial number on the mobile telephone.

3. The system of claim 1, wherein the mobile telephone executes software that obtains the serial number from an image of the financial document that the mobile telephone captures with a camera operating on the mobile telephone.

4. The system of claim 1, wherein the message includes a header that identifies the serial number obtained from the financial document, an Electronic Serial Number uniquely assigned to the mobile telephone, and one or more of a time, a date, a location, or an account associated with a transaction involving the financial document.

5. The system of claim 1, wherein the information that identifies the serial number includes one or more characters that partially identify the serial number.

6. The system of claim 1, wherein the one or more processors are further configured to triangulate a location for the mobile telephone to track one or more suspects associated with the criminal activity.

7. The system of claim 1, wherein the one or more wanted serial numbers are captured from one or more financial documents present at a financial institution.

8. The system of claim 1, wherein the financial document includes a currency document or a negotiable instrument.

9. The system of claim 1, wherein the message received from the mobile telephone further includes information associated with a driver's license, license plate, passport, visa, student identification card, or other identification document read via the mobile telephone.

10. A method for utilizing mobile telephones to combat crime, comprising:
receiving a message from a mobile telephone, wherein the message includes information that identifies a serial number that the mobile telephone obtained from a financial document;
comparing the serial number that the mobile telephone obtained from the financial document to a list that contains one or more wanted serial numbers; and
determining that the financial document may have been used in a criminal activity in response to the serial number obtained from the financial document matching any of the one or more wanted serial numbers.

11. The method of claim 10, wherein the mobile telephone executes software that converts the information that identifies the serial number into the message and suppresses the information that identifies the serial number on the mobile telephone.

12. The method of claim 10, wherein the mobile telephone executes software that obtains the serial number from an image of the financial document that the mobile telephone captures with a camera operating on the mobile telephone.

13. The method of claim 10, wherein the message includes a header that identifies the serial number obtained from the financial document, an Electronic Serial Number uniquely assigned to the mobile telephone, and one or more of a time, a date, a location, or an account associated with a transaction involving the financial document.

14. The method of claim 10, wherein the information that identifies the serial number includes one or more characters that partially identify the serial number.

15. The method of claim 10, further comprising triangulating a location for the mobile telephone to track one or more suspects associated with the criminal activity.

16. The method of claim 10, further comprising capturing the one or more wanted serial numbers from one or more financial documents present at a financial institution.

17. The method of claim 10, wherein the financial document includes a currency document or a negotiable instrument.

18. The method of claim 10, wherein the message received from the mobile telephone further includes information associated with a driver's license, license plate, passport, visa, student identification card, or other identification document read via the mobile telephone.

19. A system for utilizing mobile telephones to combat crime, comprising:
one or more receivers configured to record one or more signals detected from one or more mobile telephones during a criminal activity; and
one or more processors in communication with the one or more receivers, wherein the one or more processors are configured to:
link the one or more mobile telephones to the criminal activity; and
triangulate the one or more mobile telephones to track a suspected perpetrator of the criminal activity.

20. The system of claim 19, wherein the one or more processors are further configured to:
receive one or more messages from a computer system at a premises associated with the criminal activity; and
obtain, from the one or more messages, information that identifies one or more serial numbers that the computer system obtained from one or more currency documents, wherein the computer system executes software that converts the information that identifies the one or more serial numbers into the one or more messages and suppresses the information that identifies the one or more serial number on the computer system.

21. The system of claim 19, wherein the one or more processors are further configured to receive one or more messages from a computer system at a premises associated with the criminal activity, wherein the one or more messages include information that identifies one or more serial numbers that software executing on the computer system obtained from one or more images of one or more currency documents captured with a camera communicatively coupled to the computer system.

22. The system of claim 19, wherein the one or more processors are further configured to receive one or more messages from a computer system at a premises associated with the criminal activity, wherein the one or more messages include one or more headers that identify one or more serial numbers obtained from one or more currency documents at a premises associated with the criminal activity, Electronic Serial Numbers uniquely assigned to the one or more mobile telephones, and one or more of times, dates, locations, or accounts associated with transactions involving the one or more currency documents.

23. The system of claim 19, wherein the one or more processors are further configured to receive one or more messages from a computer system at a premises associated with the criminal activity, wherein the one or more messages include information that partially identifies one or more serial numbers that software executing on the computer system obtained from one or more currency documents.

24. A method for utilizing mobile telephones to combat crime, comprising:
recording one or more signals detected from one or more mobile telephones during a criminal activity, wherein recording the one or more detected signals includes linking the one or more mobile telephones to the criminal activity; and
triangulating the one or more mobile telephones, wherein triangulating the one or more mobile telephones includes tracking a suspected perpetrator of the criminal activity.

25. The method of claim 24, further comprising:
receiving one or more messages from a computer system at a premises associated with the criminal activity; and
obtaining, from the one or more messages, information that identifies one or more serial numbers that the computer system obtained from one or more currency documents, wherein the computer system executes software that converts the information that identifies the one or more serial numbers into the one or more messages and suppresses the information that identifies the one or more serial number on the computer system.

26. The method of claim 24, further comprising receiving one or more messages from a computer system at a premises associated with the criminal activity, wherein the one or more messages include information that identifies one or more serial numbers that software executing on the computer system obtained from one or more images of one or more currency documents captured with a camera communicatively coupled to the computer system.

27. The method of claim 24, further comprising receiving one or more messages from a computer system at a premises associated with the criminal activity, wherein the one or more messages include one or more headers that identify one or more serial numbers obtained from one or more currency documents at a premises associated with the criminal activity, Electronic Serial Numbers uniquely assigned to the one or more mobile telephones, and one or more of times, dates, locations, or accounts associated with transactions involving the one or more currency documents.

28. The method of claim 24, further comprising receiving, at a data processing facility, one or more messages from a computer system at a premises associated with the criminal activity, wherein the one or more messages include information that partially identifies one or more serial numbers that software executing on the computer system obtained from one or more currency documents.

29. The method of claim 28, wherein the one or more messages that the data processing facility receives from the computer system at the premises associated with the criminal activity include Short Message Service transmissions.

30. The method of claim 29, wherein the software executing on the computer system at the premises associated with the criminal activity suppresses the one or more serial numbers from eleven digits to forty-seven bits to partially identify the one or more serial numbers.

31. The method of claim 30, wherein the software executing on the computer system at the premises associated with the criminal activity suppresses the one or more serial numbers to reduce a transmission time associated with Short Message Service transmissions and add cryptography to the Short Message Service transmissions.

32. The method of claim 29, wherein the Short Message Service transmissions received from the computer system at the premises associated with the criminal activity can suppress and transmit more than twenty serial numbers having eleven digits and headers associated therewith per single Short Message Service transmission.

33. The method of claim 24, further comprising triangulating a computer system at a premises associated with the criminal activity utilizing global positioning system technology.

34. A method for utilizing mobile telephones to combat crime, comprising:
capturing an image associated with a suspect bill using a camera on a mobile telephone;
executing optical character recognition software on the mobile telephone to capture a serial number associated with the suspect bill, wherein the optical character recognition software captures the serial number from the image associated with the suspect bill; and
transmitting a message that identifies the serial number captured with the optical character recognition software from the mobile telephone to a data processing facility.

35. The method of claim 34, wherein executing the optical character recognition software to capture the serial number associated with the suspect bill avoids a need to transmit the image associated with the suspect bill within the message and minimizes a time to transmit the message from the mobile telephone to a data processing facility.

36. A method for utilizing mobile telephones to combat crime, comprising:
obtaining a serial number associated with a suspect bill on a mobile telephone;
comparing the serial number associated with the suspect bill to a list that contains one or more wanted serial numbers, wherein the mobile device stores the list that contains the one or more wanted serial numbers in a local memory; and
flagging the suspect bill to indicate that the suspect bill may have been used in a criminal activity in response to the serial number obtained from the suspect bill matching any of the one or more wanted serial numbers in the list stored in the local memory associated with the mobile telephone.

37. The method of claim 36, wherein obtaining the serial number associated with the suspect bill includes executing optical character recognition software on the mobile telephone to capture the serial number from an image associated with the suspect bill.

38. The method of claim 36, wherein obtaining the serial number associated with the suspect bill includes the mobile telephone receiving one or more manual inputs that identify the serial number associated with the suspect bill.

39. The method of claim 36, further comprising:
receiving one or more inputs activating a kill switch security feature associated with, software executing on the mobile telephone;
erasing the serial number associated with the suspect bill, the list that contains the one or more wanted serial numbers, and any data associated therewith from the mobile telephone in response to the one or more inputs activating the kill switch security feature associated with the software executing on the mobile telephone; and
uninstalling the software from the mobile telephone or disabling the software on the mobile telephone in response to the one or more inputs activating the kill switch security feature associated with the software.

40. The method of claim 36, further comprising:
storing the serial number associated with the suspect bill in the local memory associated with the mobile telephone; and
transmitting a message that identifies the stored serial number associated with the suspect bill from the mobile telephone to a data processing facility in response to the mobile telephone establishing a communication session with the data processing facility.

41. The method of claim 36, wherein the one or more wanted serial numbers contained in the list stored in the local memory include incomplete or partial serial numbers.

42. The method of claim 36, wherein the one or more wanted serial numbers contained in the list stored in the local memory identify currency bills designated to be used in an undercover operation to infiltrate a Hawala network.

43. A method for utilizing mobile telephones to combat crime, comprising:
obtaining, on a computing device, a serial number and denomination associated with a suspect bill from an image associated with the suspect bill;
querying a database containing all valid banknote serial numbers with the serial number and denomination associated with the suspect bill; and
receiving, at the computing device, a notification relating to a legitimacy associated with the suspect bill based on whether the serial number and denomination associated with the suspect bill matches any of the valid banknote serial numbers in the database.

44. The method of claim 43, wherein the computing device includes a mobile telephone that stores the database containing all valid banknote serial numbers in a local memory associated therewith.

45. The method of claim 44, wherein the database occupies approximately five-hundred kilobytes in the local memory associated with the mobile telephone.

46. The method of claim 43, wherein the computing device includes a desktop computer or a laptop computer.

47. A method for utilizing mobile telephones to combat crime, comprising:
capturing one or more images associated with a transaction involving a suspect financial document using a camera on a mobile telephone, wherein the one or more images include an image of the suspect financial document and an image of an identification document associated with an individual that used the suspect financial document in the transaction;
capturing video that documents one or more events associated with the transaction involving the suspect financial document using a video function on the mobile telephone; and
transmitting one or more messages that include the one or more images associated with the transaction and the video that documents the one or more events associated with the transaction from the mobile telephone to a control center.

48. The method of claim 47, wherein the mobile telephone transmits the one or more messages to the control center using a Bluetooth or Multimedia Messaging Service communication protocol.

49. The method of claim 47, wherein the one or more events documented in the video relate to detaining or arresting the individual that used the suspect financial document.

50. The method of claim 47, wherein the one or more events documented in the video relate to the transaction in which the individual used the suspect financial document.

51. The method of claim 47, further comprising receiving, at the mobile telephone, a notification from the control center in response to the one or more messages that include the one or more images associated with the transaction and the video that documents the one or more events associated with the transaction, wherein the notification includes feedback on the suspect financial document and the identification document in the one or more images.

52. A method for managing currency serial numbers to combat crime, comprising:
obtaining, at a money counting device, serial numbers associated with a substantially high volume of currency documents counted in the money counting device;
uploading the serial numbers associated with the currency documents counted in the money counting device from a local processor associated with the money counting device to a control center having a database that stores information relating to wanted serial numbers, wherein the control center adds information relating to the serial numbers uploaded from the money counting device to the information stored in the database; and
downloading the information stored in the database, including the information relating to the wanted serial numbers, from the control center to the local processor associated with the money counting device.

53. A method for utilizing mobile telephones to combat crime, comprising:
obtaining, at a mobile telephone, one or more serial numbers associated with one or more currency documents;
uploading the one or more serial numbers associated with the one or more currency documents from the mobile telephone to a control center having a database that stores information relating to wanted serial numbers, wherein the control center adds information relating to the one or more serial numbers uploaded from the mobile telephone to the information stored in the database; and
downloading the information stored in the database, including the information relating to the wanted serial numbers, from the control center to a local memory associated with the mobile telephone.
